(19) United States
(12) Patent Application Publication
(10) Pub. No.: US 2026/0057833 A1
(43) Pub. Date: Feb. 26, 2026

(54) DISPLAY DEVICE AND METHOD OF DRIVING THE SAME, AND ELECTRONIC DEVICE

(71) Applicant: Samsung Display Co., Ltd., Yongin-si (KR)

(72) Inventors: Hee Beom YANG, Yongin-si (KR); Gyu Hyeon KIM, Yongin-si (KR); Neung Beom LEE, Yongin-si (KR); Yong Sik JUNG, Yongin-si (KR)

(21) Appl. No.: 19/215,044

(22) Filed: May 21, 2025

(30) Foreign Application Priority Data
Aug. 26, 2024 (KR) 10-2024-0114304

(51) Int. Cl. G09G 3/3233; G09G 3/32

(52) U.S. Cl. CPC G09G 3/3233; G09G 3/32; G09G 2300/0842; G09G 2310/08; G09G 2320/0209; G09G 2330/021; G09G 2330/028; G09G 2354/00

(57) ABSTRACT

A display device including: pixels generating a predetermined light in response to a driving current supplied from a first driving power source; a data driver generating data signals using gamma voltages and supplying the data signals to the pixels; a first voltage generator generating a first raw reference voltage and a first reference voltage in which rising and falling of the first driving power source are compensated; a second voltage generator generating a second raw reference voltage and a second reference voltage in which rising of the first driving power source is compensated; a selector supplying the first raw reference voltage and the first reference voltage, or the second raw reference voltage and the second reference voltage to a gamma driver in response to a selection signal; and a timing controller comparing data in units of horizontal lines and generating the selection signal based on a comparison result.

### CROSS-REFERENCE TO RELATED APPLICATION

The present application claims priority to and the benefit of Korean Patent Application No. 10-2024-0114304, filed on Aug. 26, 2024, in the Korean Intellectual Property Office, the entire disclosure of which is incorporated herein by.

### BACKGROUND

### 1. Field

Aspects of some embodiments of the present disclosure relate to a display device and a method of driving the same, and electronic device.

### 2. Description of the Related Art

As the information society develops, consumer demand for display devices for displaying images is increasing in various forms. For example, display devices may be applied to various electronic devices such as smartphones, digital cameras, notebook computers, navigation systems, and smart televisions.

The above information disclosed in this Background section is only for enhancement of understanding of the background and therefore the information discussed in this Background section does not necessarily constitute prior art.

### SUMMARY

Aspects of some embodiments of the present disclosure include a display device and a method of driving the same which can relatively improve display quality while relatively reducing power consumption of the display device.

A display device according to some embodiments of the present disclosure may include pixels generating a predetermined light in response to a driving current supplied from a first driving power source; a data driver generating data signals using gamma voltages and supplying the data signals to the pixels; a first voltage generator generating a first raw reference voltage and a first reference voltage in which rising and falling of the first driving power source are compensated; a second voltage generator generating a second raw reference voltage and a second reference voltage in which rising of the first driving power source is compensated; a selector supplying the first raw reference voltage and the first reference voltage, or the second raw reference voltage and the second reference voltage to a gamma driver in response to a selection signal; and a timing controller comparing data in units of horizontal lines and generating the selection signal based on a comparison result.

According to some embodiments, the gamma driver may generate the gamma voltages by dividing the first raw reference voltage and the first reference voltage, or the second raw reference voltage and the second reference voltage.

According to some embodiments, the selector may supply the first raw reference voltage and the first reference voltage to the gamma driver when a first level selection signal is input, and supply the second raw reference voltage and the second reference voltage to the gamma driver when a second level selection signal is input.

According to some embodiments, the timing controller may include a first judgment unit generating a first judgment value corresponding to a difference between data of first pixels of a previous horizontal line and data of second pixels of a current horizontal line, and generating a first judgment signal when the first judgment value is greater than or equal to a threshold value; and a second judgment unit comparing the data of the first pixels and the data of the second pixels to generate a second judgment value corresponding to whether data has changed, and generating a second judgment signal when the second judgment value is greater than or equal to a first threshold value and less than or equal to a second threshold value.

According to some embodiments, each of the first judgment unit and the second judgment unit may compare data of a first pixel and a second pixel located on the same vertical line.

According to some embodiments, assuming that a maximum value of the first judgment value is 100, the threshold value may be set to a value greater than or equal to 40.

According to some embodiments, assuming that a maximum value of the second judgment value is 100, the first threshold value may be set to a value greater than or equal to 5, and the second threshold value may be set to a value higher than the first threshold value and less than or equal to 70.

According to some embodiments, the timing controller may further include a controller supplying the first level selection signal to the selector when the first judgment signal and the second judgment signal are input, and supplying the second level selection signal to the selector in other cases.

According to some embodiments, the display device may further include a proximity sensor detecting whether an object is approaching and generating a proximity signal when the object is positioned within a predetermined distance.

According to some embodiments, the timing controller may further include a controller supplying the first level selection signal to the selector when the first judgment signal, the second judgment signal, and the proximity signal are input, and supplying the second level selection signal to the selector in other cases.

According to some embodiments, the display device may further include a dimming level judgment unit generating a third judgment signal when a current dimming level of the display device is greater than or equal to a predetermined third threshold value.

According to some embodiments, the third threshold value may have a value less than or equal to 50% of a maximum dimming level at which the display device can be driven.

According to some embodiments, the timing controller may further include a controller supplying the first level selection signal to the selector when the first judgment signal, the second judgment signal, and the third judgment signal are input, and supplying the second level selection signal to the selector in other cases.

A method of driving a display device according to embodiments of the present disclosure may include generating a first raw reference voltage and a first reference voltage in which rising and falling of a first driving power source are compensated; generating a second raw reference voltage and a second reference voltage in which rising of the first driving power source is compensated; comparing data in units of horizontal lines; generating gamma voltages using the first raw reference voltage and the first reference voltage, or the second raw reference voltage and the second reference voltage based on a comparison result of the data; and generating a data signal using the gamma voltages.

According to some embodiments, the comparing the data in units of horizontal lines may include generating a first judgment value corresponding to a difference between data of first pixels of a previous horizontal line and data of second pixels of a current horizontal line; generating a first judgment signal when the first judgment value is greater than or equal to a predetermined threshold value; generating a second judgment value corresponding to whether the data of the first pixels and the data of the second pixels have changed; and generating a second judgment signal when the second judgment value is greater than or equal to a first threshold value and less than or equal to a second threshold value.

According to some embodiments, the generating the gamma voltages may include generating the gamma voltages using the first raw reference voltage and the first reference voltage when the first judgment signal and the second judgment signal are input, and generating the gamma voltages using the second raw reference voltage and the second reference voltage in other cases.

According to some embodiments, the method of driving the display device may further include detecting whether an object is approaching and generating a proximity signal when the object is positioned within a predetermined distance.

According to some embodiments, the generating the gamma voltages may include generating the gamma voltages using the first raw reference voltage and the first reference voltage when the first judgment signal, the second judgment signal, and the proximity signal are input, and generating the gamma voltages using the second raw reference voltage and the second reference voltage in other cases.

According to some embodiments, the method of driving the display device may further include generating a third judgment signal when a current dimming level of the display device is greater than or equal to a predetermined third threshold value.

According to some embodiments, the generating the gamma voltages may include generating the gamma voltages using the first raw reference voltage and the first reference voltage when the first judgment signal, the second judgment signal, and the third judgment signal are input, and generating the gamma voltages using the second raw reference voltage and the second reference voltage in other cases.

According to some embodiments of the present disclosure, an electronic device includes a processor to provide input image data; a display device to display an image based on the input image data. The display device includes pixels generating a predetermined light in response to a driving current supplied from a first driving power source; a data driver generating data signals using gamma voltages and supplying the data signals to the pixels; a first voltage generator generating a first raw reference voltage and a first reference voltage in which rising and falling of the first driving power source are compensated; a second voltage generator generating a second raw reference voltage and a second reference voltage in which rising of the first driving power source is compensated; a selector supplying the first raw reference voltage and the first reference voltage, or the second raw reference voltage and the second reference voltage to a gamma driver in response to a selection signal; and a timing controller comparing data in units of horizontal lines and generating the selection signal based on a comparison result.

The characteristics of embodiments according to the present disclosure are not limited to the characteristics mentioned above, and other characteristics not mentioned will be more clearly understood by those skilled in the art from the description below.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a diagram illustrating a display device according to some embodiments of the present disclosure.

FIG. 2 is a diagram illustrating a pixel according to some embodiments of the present disclosure.

FIGS. 3A and 3B are diagrams illustrating raw reference voltages generated from a first voltage generator and a second voltage generator shown in FIG. 1.

FIG. 4 is a diagram illustrating further details of the first voltage generator shown in FIG. 1.

FIG. 5A is a diagram illustrating an image of a display unit corresponding to a specific pattern when gamma voltages are generated using the second voltage generator.

FIG. 5B is a diagram illustrating an image of the display unit corresponding to a specific pattern when gamma voltages are generated using the first voltage generator.

FIG. 6 is a diagram illustrating a timing controller according to some embodiments of the present disclosure.

FIG. 7 is a waveform diagram illustrating the operation process of the timing controller shown in FIG. 6.

FIG. 8 is a diagram illustrating a display device according to some embodiments of the present disclosure.

FIG. 9 is a diagram illustrating further details of a timing controller shown in FIG. 8.

FIG. 10 is a waveform diagram illustrating the operation process of the timing controller shown in FIG. 9.

FIG. 11 is a diagram illustrating further details of the timing controller shown in FIG. 8.

FIG. 12 is a waveform diagram illustrating the operation process of the timing controller shown in FIG. 11.

FIG. 13 is a flow diagram illustrating aspects of a method of driving a display device according to some embodiments of the present disclosure.

FIG. 14 is a flow diagram illustrating aspects of a method of driving a display device according to some embodiments of the present disclosure.

FIG. 15 is a schematic block diagram illustrating an electronic device including a display device according to some embodiments.

FIG. 16 is a schematic diagram illustrating an example where the electronic device of FIG. 15 is a smartphone.

FIG. 17 is a schematic diagram illustrating an example where the electronic device of FIG. 15 is a tablet computer.

### DETAILED DESCRIPTION

Hereinafter, aspects of some embodiments of the present disclosure will be described in more detail with reference to the accompanying drawings so that those of ordinary skill in the art may more easily implement the embodiments according to the present disclosure. The embodiments according to the present disclosure may be embodied in various different forms and is not limited to the embodiments described herein.

In order to more clearly describe aspects of embodiments according to the present disclosure, parts that are not related to the description may be omitted, and the same or similar components are denoted by the same reference numerals throughout the specification. Therefore, the reference numerals described above may also be used in other drawings.

In addition, in the description, the expression “is the same” may mean “substantially the same”. That is, it may be the same enough to convince those of ordinary skill in the art to be the same. In other expressions, “substantially” may be omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, and may optionally be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

The term “connection” between two components may mean that both of an electrical connection and a physical connection are used inclusively, but embodiments according to the present disclosure are not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of embodiments according to the present disclosure

Meanwhile, embodiments according to the present disclosure are not limited to the embodiments disclosed below, and may be modified in various forms and may be implemented. In addition, each of the embodiments disclosed below may be implemented alone or in combination with at least one of other embodiments.

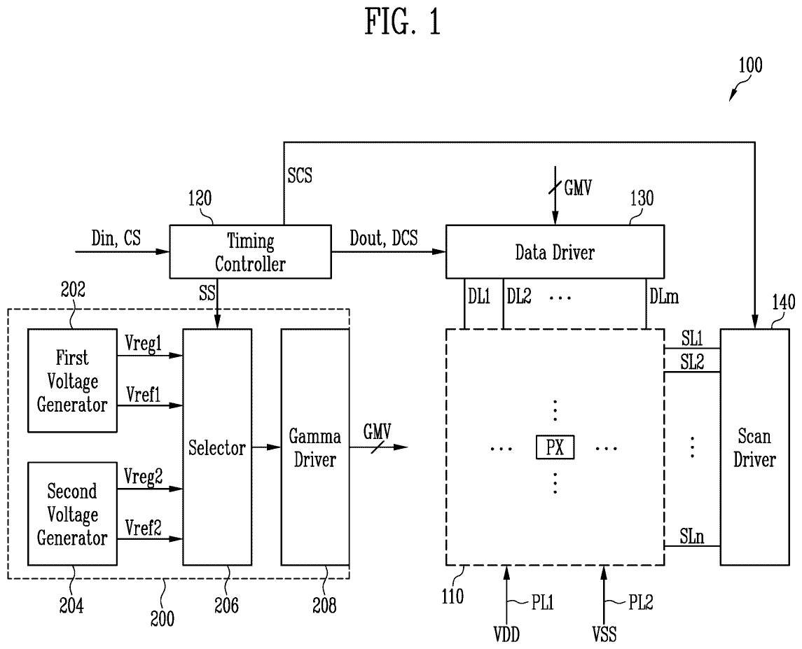

FIG. 1 is a diagram illustrating a display device according to some embodiments of the present disclosure.

Referring to FIG. 1, a display device 100 according to some embodiments of the present disclosure may include a display unit 110, a timing controller 120, a data driver 130, a scan driver 140, and a gamma voltage generator 200. The timing controller 120, the data driver 130, and the gamma voltage generator 200 may be configured as a single IC or may be configured as a plurality of ICs.

The display unit 110 may have pixels PX connected to scan lines SL1, SL2, . . . , and SLn, data lines DL1, DL2, . . . , and DLm, and power source lines PL1 and PL2, where n and m may be natural numbers greater than or equal to 3. Although FIG. 1 illustrates a single pixel PX in the display device 100, as a person having ordinary skill in the art would appreciate, the display device 100 may include any suitable number of pixels PX according to the design and size of the display device 100.

The pixels PX may be selected in units of horizontal lines in response to an enable scan signal supplied to the scan lines SL1 to SLn, and pixels PX selected by the enable scan signal may receive a data signal from a data line (one of DL1 to DLm) to which they are connected. The pixels PX receiving the data signal may generate light with a luminance (e.g., a set or predetermined luminance) by controlling the amount of current supplied from a first power source line PL1 to a second power source line PL2 via a light emitting element in response to a voltage of the data signal.

A first driving power source VDD may be input to the first power source line PL1, and a second driving power source VSS may be input to the second power source line PL2. During a period in which the pixels PX emit light, the first driving power source VDD may have a higher voltage than the second driving power source VSS.

The scan driver 140 may receive a scan driving signal SCS from the timing controller 120. The scan driving signal SCS may include at least one scan start signal and clock signals required to drive the scan driver 140. The scan driver 140 may generate the enable scan signal while shifting the scan start signal in response to a clock signal.

A scan signal may be divided into an enable scan signal and a disable scan signal. The enable scan signal may have a gate-on voltage so that a transistor included in a pixel PX can be turned on. As an example, the enable scan signal supplied to a P-type transistor may have a logic low level voltage.

The disable scan signal may have a gate-off voltage so that a transistor included in a pixel PX can be turned off. As an example, the disable scan signal supplied to a P-type transistor may have a logic high level voltage.

The data driver 130 may receive output data Dout and a data driving signal DCS from the timing controller 120. The data driver 130 may receive gamma voltages GMV from the gamma voltage generator 200. The data driving signal DCS may include a sampling signal and/or timing signals required to drive the data driver 130.

The data driver 130 may generate the data signal based on the data driving signal DCS, the output data Dout, and the gamma voltages GMV. As an example, the data driver 130 may select one of the gamma voltages GMV corresponding to each grayscale of the output data Dout and supply the selected voltage as the data signal to the data lines DL1 to DLm. The data driver 130 may supply the data signal in units of one horizontal period.

The gamma voltage generator 200 may generate the gamma voltages GMV and supply the generated gamma voltages GMV to the data driver 130. The gamma voltages GMV may be voltages corresponding to each grayscale. As an example, the gamma voltages GMV may include voltages corresponding to grayscales of 0 to 255.

The gamma voltage generator 200 may include a first voltage generator 202, a second voltage generator 204, a selector 206, and a gamma driver 208.

The first voltage generator 202 may generate a first raw reference voltage Vreg1 and a first reference voltage Vref1. The first raw reference voltage Vreg1 and the first reference voltage Vref1 may be base voltages for generating the gamma voltages GMV. As an example, the gamma driver 208 may generate the gamma voltages GMV by dividing the first raw reference voltage Vreg1 and the first reference voltage Vref1.

The first voltage generator 202 may generate the first raw reference voltage Vreg1 and the first reference voltage Vref1 so that the rising and falling of the first driving power source VDD are compensated. The first voltage generator 202 may be composed of various known circuits.

When the first raw reference voltage Vreg1 and the first reference voltage Vref1 are generated so that the rising and falling of the first driving power source VDD are compensated, an image may be stably displayed regardless of the pattern (or image) displayed on the display unit 110. However, when the gamma voltages GMV are generated using the first raw reference voltage Vreg1 and the first reference voltage Vref1, power consumption of the display device 100 may increase.

The second voltage generator 204 may generate a second raw reference voltage Vreg2 and a second reference voltage Vref2. The second raw reference voltage Vreg2 and the second reference voltage Vref2 may be base voltages for generating the gamma voltages GMV. As an example, the gamma driver 208 may generate the gamma voltages GMV by dividing the second raw reference voltage Vreg2 and the second reference voltage Vref2.

The second voltage generator 204 may generate the second raw reference voltage Vreg2 and the second reference voltage Vref2 so that the rising of the first driving power source VDD is compensated. The second voltage generator 204 may be composed of various known circuits.

When the gamma voltages GMV are generated using the second raw reference voltage Vreg2 and the second reference voltage Vref2, power consumption can be relatively reduced compared to when the gamma voltages GMV are generated using the first raw reference voltage Vreg1 and the first reference voltage Vref1. However, when some patterns are displayed on the display unit 110, a line crosstalk phenomenon may occur.

The selector 206 may supply the first raw reference voltage Vreg1 and the first reference voltage Vref1, or the second raw reference voltage Vreg2 and the second reference voltage Vref2 to the gamma driver 208 based on a selection signal SS input from the timing controller 120.

The gamma driver 208 may generate the gamma voltages GMV using the first raw reference voltage Vreg1 and the first reference voltage Vref1, or the second raw reference voltage Vreg2 and the second reference voltage Vref2 supplied from the selector 206.

As an example, the gamma driver 208 may generate the gamma voltages GMV by dividing the first raw reference voltage Vreg1 and the first reference voltage Vref1 supplied from the first voltage generator 202 through the selector 206. As an example, the gamma driver 208 may generate the gamma voltages GMV by dividing the second raw reference voltage Vreg2 and the second reference voltage Vref2 supplied from the second voltage generator 204 through the selector 206.

The timing controller 120 may receive input data Din and a control signal CS from a host system through an interface. As an example, the timing controller 120 may receive the input data Din and the control signal CS from at least one of a GPU (Graphics Processing Unit), a CPU (Central Processing Unit), or an AP (Application Processor) included in the host system. The control signal CS may include various signals (for example, dimming level information and the like) including a clock signal. The timing controller 120 may rearrange the input data Din to match the specifications of the display device 100. In addition, the timing controller 120 may correct the input data Din to generate the output data Dout and supply the output data Dout to the data driver 140. According to some embodiments, the timing controller 120 may correct the input data Din in response to the optical measurement results measured during a manufacturing process.

The timing controller 120 may generate the scan driving signal SCS and the data driving signal DCS based on a control signal CS. The scan driving signal SCS and the data driving signal DCS may be supplied to the scan driver 140 and the data driver 130, respectively.

The timing controller 120 may compare data in units of horizontal lines and supply a first level (for example, a logic high level voltage) selection signal SS or a second level (for example, a logic low level voltage) selection signal SS to the selector 206 in response to the comparison result. When the first level selection signal SS is input, the selector 206 may supply the first raw reference voltage Vreg1 and the first reference voltage Vref1 to the gamma driver 208. When the second level selection signal SS is input, the selector 206 may supply the second raw reference voltage Vreg2 and the second reference voltage Vref2 to the gamma driver 208.

The first level may be the logic high level voltage, and the second level may be the logic low level voltage, but embodiments of the present disclosure are not limited thereto. As an example, the first level may have the logic low level voltage, and the second level may have the logic high level voltage.

According to some embodiments, the timing controller 120 may detect a pattern that may cause line crosstalk while comparing data in units of horizontal lines, and supply the selection signal SS in response to the detection result. As an example, when a pattern that may cause line crosstalk is detected, the timing controller 120 may supply the first level selection signal SS to the selector 206. As an example, when a pattern that may cause line crosstalk is not detected, the timing controller 120 may supply the second level selection signal SS to the selector 206.

According to some embodiments of the present disclosure, the display device 100 may include a flat panel display device, a curved display device in which a portion of the display unit 110 is curved, a flexible display device in which a portion can be folded or bent, or a stretchable display device in which a portion can be stretched.

According to some embodiments of the present disclosure, the display device 100 may be a device that displays a moving image or a still image, and may include a portable electronic device such as a mobile phone, a smart phone, a tablet personal computer (PC), a smart watch, a watch phone, a mobile communication terminal, an electronic notebook, an electronic book, a PMP (Portable Multimedia Player), a navigation device, and an UMPC (Ultra Mobile PC). According to some embodiments of the present disclosure, the display device 100 may include an electronic device such as television, a laptop, a monitor, a billboard, or an Internet of Things (IoT).

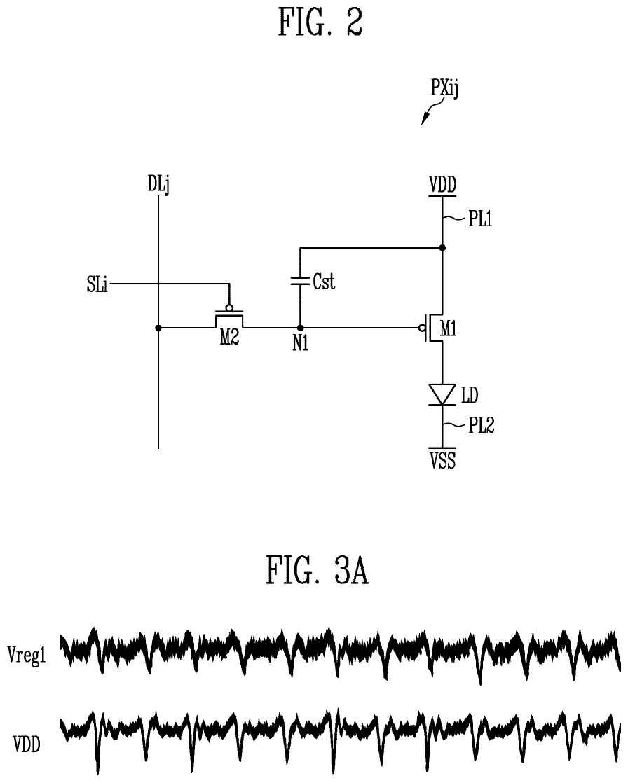

FIG. 2 is a diagram illustrating a pixel according to some embodiments of the present disclosure. Although FIG. 2 illustrates various components in a pixel according to some embodiments, embodiments according to the present disclosure are not limited thereto, and according to various embodiments, the pixel may include additional components without departing from the spirit and scope of embodiments according to the present disclosure.

FIG. 2 shows a pixel PXij connected to an i-th scan line SLi and a j-th data line DLj, where i may be a natural number greater than or equal to 1 and less than or equal to n, and j may be a natural number greater than or equal to 1 and less than or equal to m.

According to some embodiments of the present disclosure, the structure of the pixel PXij is not limited to FIG. 2 and may be implemented with various known circuits.

Referring to FIG. 2, the pixel PXij according to some embodiments of the present disclosure may include a first transistor M1, a second transistor M2, a light emitting element LD, and a storage capacitor Cst.

The light emitting element LD may be connected between the first power source line PL1 and the second power source line PL2. As an example, an anode electrode of the light emitting element LD may be electrically connected to the first power source line PL1 via the first transistor M1, and a cathode electrode of the light emitting element LD may be electrically connected to the second power source line PL2. The light emitting element LD may generate light of a luminance (e.g., a set or predetermined luminance) in response to the amount of current supplied from the first power source line PL1 to the second power source line PL2.

The light emitting element LD may be selected as an organic light emitting diode. In addition, the light emitting element LD may be selected as an inorganic light emitting diode such as a micro LED (light emitting diode) or a quantum dot light emitting diode. In addition, the light emitting element LD may be an element composed of a composite of organic and inorganic materials. In FIG. 2, the pixel PXij is shown as including a single light emitting element LD, but in other embodiments, the pixel PXij may include a plurality of light emitting elements LD, and the plurality of light emitting elements LD may be connected in series, in parallel, or in series and parallel.

A first electrode of the first transistor M1 may be connected to the first power source line PL1, and a second electrode of the first transistor M1 may be connected to the anode electrode of the light emitting element LD. In addition, a gate electrode of the first transistor M1 may be connected to a first node N1. The first transistor M1 may control the amount of current flowing from the first power source line PL1 to the second power source line PL2 via the light emitting element LD in response to a voltage of the first node N1.

The second transistor M2 may be connected between the j-th data line DLj and the first node N1. In addition, a gate electrode of the second transistor M2 may be connected to the i-th scan line SLi. The second transistor M2 may be turned on when the enable scan signal is supplied to the i-th scan line SLi to electrically connect the j-th data line DLj and the first node N1. When the data line DLj and the first node N1 are electrically connected to each other, the data signal from the j-th data line DLj may be supplied to the first node N1.

The storage capacitor Cst may be connected between the first power source line PL1 and the first node N1. The storage capacitor Cst may maintain a voltage of the data signal supplied to the first node N1 for one frame period.

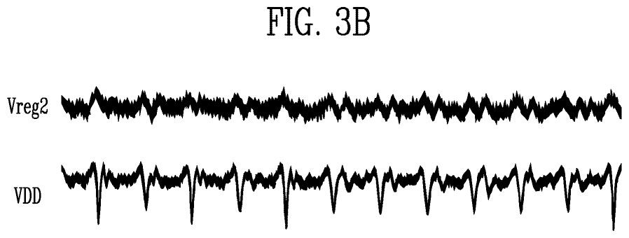

FIGS. 3A and 3B are diagrams illustrating raw reference voltages generated from a first voltage generator and a second voltage generator shown in FIG. 1.

Referring to FIG. 3A, the first raw reference voltage Vreg1 generated from the first voltage generator 202 may fall and rise in response to the falling and rising of the first driving power source VDD. In this case, the gamma voltages GMV may be generated so that the falling and rising of the first driving power source VDD are compensated.

Referring to FIG. 3B, the second raw reference voltage Vreg2 generated from the second voltage generator 204 may rise in response to the rising of the first driving power source VDD. In this case, the gamma voltages GMV may be generated so that the rising of the first driving power source VDD is compensated.

In general, when the gamma voltages GMV are generated based on the first raw reference voltage Vreg1 and the first reference voltage Vref1, display quality of the display unit 110 can be relatively improved compared to when the gamma voltages GMV are generated based on the second raw reference voltage Vreg2 and the second reference voltage Vref2. However, the first voltage generator 202 may consume more power compared to the second voltage generator 204.

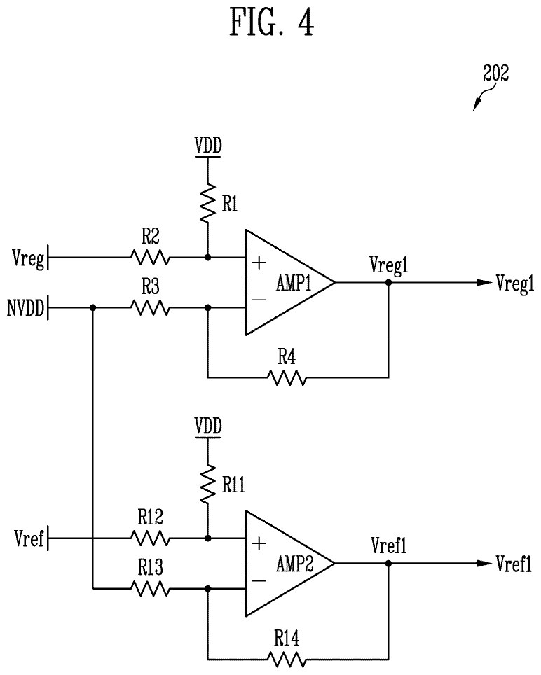

FIG. 4 is a diagram illustrating further details of the first voltage generator shown in FIG. 1.

Referring to FIG. 4, the first voltage generator 202 according to some embodiments of the present disclosure may include a first amplifier AMP1 (or differential amplifier) and a second amplifier AMP2 (or differential amplifier).

A non-inverting terminal (+) of the first amplifier AMP1 may be electrically connected to a first resistor R1 and a second resistor R2. The first resistor R1 may receive the first driving power source VDD from the display unit 110. The second resistor R2 may receive a raw reference voltage Vreg.

The first driving power source VDD input to the first resistor R1 may be supplied from the display unit 110 and may rise and fall in response to the driving environment of the display unit 110. The raw reference voltage Vreg input to the second resistor R2 may have a higher voltage compared to the first driving power source VDD.

An inverting terminal (−) of the first amplifier AMP1 may be electrically connected to a third resistor R3 and a fourth resistor R4. The third resistor R3 may receive a reference target voltage NVDD. The fourth resistor R4 may be connected between an inverting terminal (−) and an output terminal of the second amplifier AMP2.

The reference target voltage NVDD input to the third resistor R3 may be a target voltage of the first driving power source VDD, for example, a voltage for normally driving the pixels PX of the display unit 110.

The first to fourth resistors R1 to R4 may have the same resistance value, but embodiments according to the present disclosure are not limited thereto. In addition, the first to fourth resistors R1 to R4 may correspond to line resistors or may be composed of separate components.

The first amplifier AMP1 may output the first raw reference voltage Vreg1 as shown in Mathematical Equation 1 below.

$$V reg 1 = ( NVDD - VDD ) + Vreg \qquad Mathematical Equation 1$$

Referring to Mathematical Equation 1, the first raw reference voltage Vreg1 may correspond to a value obtained by adding the raw reference voltage Vreg to a voltage difference between the reference target voltage NVDD and the first driving power source VDD. In this case, the rising and falling of the first driving power source VDD may be reflected to generate the first raw reference voltage Vreg1. Therefore, when the gamma voltages GMV are generated using the first raw reference voltage Vreg1, data signals reflecting the rising and falling of the first driving power source VDD may be generated.

A non-inverting terminal (+) of the second amplifier AMP2 may be electrically connected to a first resistor R11 and a second resistor R12. The first resistor R11 may receive the first driving power source VDD from the display unit 110. The second resistor R2 may receive a reference voltage Vref.

The first driving power source VDD input to the first resistor R11 may be supplied from the display unit 110 and may rise and fall in response to the driving environment of the display unit 110. The reference voltage Vref input to the second resistor R2 may have a lower voltage compared to the raw reference voltage Vreg.

The inverting terminal (−) of the second amplifier AMP2 may be electrically connected to a third resistor R13 and a fourth resistor R14. The third resistor R13 may receive the reference target voltage NVDD. The fourth resistor R14 may be connected between the inverting terminal (−) and the output terminal of the second amplifier AMP2.

The first to fourth resistors R11 to R14 may have the same resistance value, but embodiments according to the present disclosure are not limited thereto. In addition, the first to fourth resistors R11 to R14 may correspond to line resistors or may be composed of separate components.

The second amplifier AMP2 may output the first reference voltage Vref1 as shown in Mathematical Equation 2 below.

$$V ref 1 = ( NVDD - VDD ) + Vref \qquad Mathematical Equation 2$$

Referring to Mathematical Equation 2, the first reference voltage Vref1 may correspond to a value obtained by adding the reference voltage Vref to a voltage difference between the reference target voltage NVDD and the first driving power source VDD. In this case, the rising and falling of the first driving power source VDD may be reflected to generate the first reference voltage Vref1. Therefore, when the gamma voltages GMV are generated using the first reference voltage Vref1, data signals reflecting the rising and falling of the first driving power source VDD may be generated.

The first voltage generator 202 described above may be implemented with various known circuits as well as the structure shown in FIG. 4. Similarly, the second voltage generator 204 may also be implemented with various known circuits.

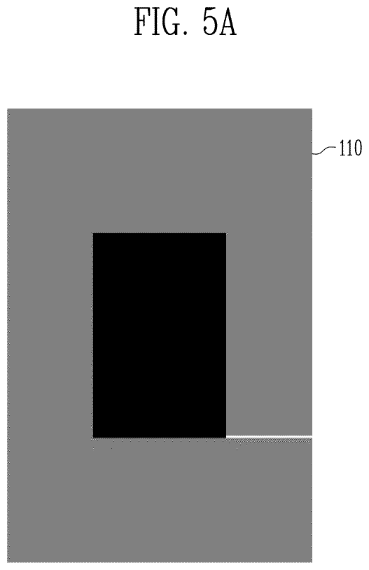

FIG. 5A is a diagram illustrating an image of a display unit corresponding to a specific pattern when gamma voltages are generated using the second voltage generator. FIG. 5B is a diagram illustrating an image of the display unit corresponding to a specific pattern when gamma voltages are generated using the first voltage generator.

Referring to FIGS. 1 and 5A, when the second voltage generator 204 is used, the gamma voltage generator 200 may generate the gamma voltages GMV using the second raw reference voltage Vreg2 and the second reference voltage Vref2. As described above, the second raw reference voltage Vreg2 and the second reference voltage Vref2 may be voltages in which the rising of the first driving power source VDD is compensated and the falling of the first driving power source VDD is not compensated.

When the gamma voltages GMV are generated using the second raw reference voltage Vreg2 and the second reference voltage Vref2, when an image of a specific pattern, for example, a black image is displayed in some area of the center of the display unit 110 and an image having a higher grayscale than black is displayed in other areas, noise in the form of horizontal lines may be detected (that is, the line crosstalk phenomenon).

Referring to FIGS. 1 and 5B, when the first voltage generator 202 is used, the gamma voltage generator 200 may generate the gamma voltages GMV using the first raw reference voltage Vreg1 and the first reference voltage Vref1. As described above, the first raw reference voltage Vreg1 and the first reference voltage Vref1 may be voltages in which the rising and falling of the first driving power source VDD are compensated.

When the gamma voltages GMV are generated using the first raw reference voltage Vreg1 and the first reference voltage Vref1, noise in the form of horizontal lines may not occur even if an image of a specific pattern is displayed.

According to some embodiments of the present disclosure, the display device 100 may generate the gamma voltages GMV using the second voltage generator 204 to relatively reduce the power consumption when displaying a general image.

According to some embodiments of the present disclosure, the display device 100 may generate the gamma voltages GMV using the first voltage generator 202 to relatively improve display quality when displaying an image of a specific pattern.

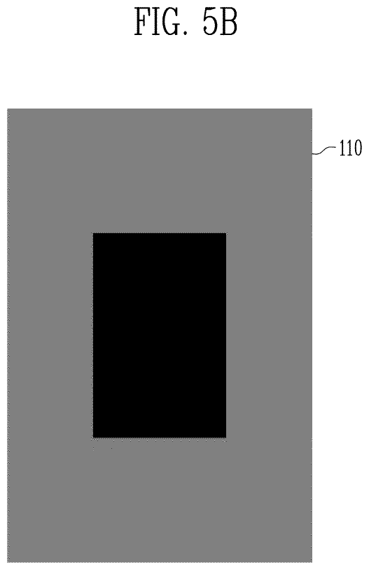

FIG. 6 is a diagram illustrating a timing controller according to some embodiments of the present disclosure. In FIG. 6, only components necessary for explaining the present disclosure among various components of the timing controller 120 are shown.

Referring to FIG. 6, the timing controller 120 according to some embodiments of the present disclosure may include a first judgment unit 122, a second judgment unit 124, and a controller 126.

The first judgment unit 122 may detect the amount of change in data in units of horizontal lines. As an example, the first judgment unit 122 may compare the amount of change in data of a first pixel located on a previous horizontal line (for example, an (i-1)th horizontal line) with the amount of change in data of a second pixel located on a current horizontal line (for example, an i-th horizontal line). Here, the first pixel and the second pixel may be located on the same vertical line (for example, connected to the same data line).

The first judgment unit 122 may compare data (for example, bits of data or grayscales of data) of each of first pixels located on the (i-1)th horizontal line with data of each of second pixels located on the i-th horizontal line. The first judgment unit 122 may compare data of the first pixel and data of the second pixel located on the same vertical line. The first judgment unit 122 may obtain an absolute value of a value obtained by subtracting the data of each of the second pixels from the data of each of the first pixels as a first judgment value.

The first judgment unit 122 may compare the first judgment value with a threshold value (e.g., a set or predetermined threshold value). When the first judgment value is greater than or equal to the threshold value, the first judgment unit 122 may determine that a specific pattern image that may cause crosstalk will be displayed on the display unit 110, and may supply a first judgment signal JS1 (for example, a logic high level voltage) to the controller 126. When the first judgment value is less than the threshold value, the first judgment unit 122 may determine that an image that may not cause crosstalk will be displayed on the display unit 110, and may not supply the first judgment signal JS1 to the controller 126 (or supply a logic low level voltage).

When a maximum value of the first judgment value (for example, the first judgment value when white (or black) is displayed on the (i-1)th horizontal line and black (or white) is displayed on the i-th horizontal line) is assumed to be 100 (or 100%), the threshold value may be set to a value greater than or equal to approximately 40 (or 40%) (for example, a value less than or equal to 80 (or 80%)).

The second judgment unit 124 may detect whether data has changed in units of horizontal lines. The second judgment unit 124 may determine the number of pixels in which data has changed in units of horizontal lines. As an example, the second judgment unit 124 may determine whether data has changed by comparing the data of the first pixel located in the previous horizontal line (for example, the (i-1)th horizontal line) with the data of the second pixel located in the current horizontal line (for example, the i-th horizontal line) and located in the same vertical line as the first pixel.

The second judgment unit 124 may compare the data of each of the first pixels located on the (i-1)th horizontal line with the data of each of the second pixels located on the i-th horizontal line. The second judgment unit 124 may compare the data of the first pixel and the data of the second pixel located on the same vertical line, and obtain the number of pixels whose data has changed as a second judgment value in response to the comparison result.

The second judgment unit 124 may compare the second judgment value with first and second threshold values (e.g., set or predetermined first and second threshold values). The first threshold value may have a lower value compared to the second threshold value.

when the second judgment value is greater than or equal to the first threshold value and less than or equal to the second threshold value, the second judgment unit 124 may determine that a specific pattern image that may cause crosstalk will be displayed on the display unit 110, and may supply a second judgment signal JS2 (for example, a logic high level voltage) to the controller 126. when the second judgment value is not positioned between the first threshold value and the second threshold value, the second judgment unit 124 may determine that an image that may not cause crosstalk will be displayed on the display unit 110, and may not supply the second judgment signal JS2 to the controller 126 (or supply a logic low level voltage).

When a maximum value of the second judgment value is set to 100 (or 100%), the first threshold value may have a value greater than or equal to 5 (or 5%) (for example, a value between 5 and 10), and the second threshold value may have a value less than or equal to 70 (or 70%). When more than 71% of the number of pixels located on a horizontal line has changed, data of most pixels may have changed and line crosstalk may not be visually recognized by a user. As an example, when white (or black) is displayed on the (i-1)th horizontal line and black (or white) is displayed on the i-th horizontal line, line crosstalk may not occur or may not be visually recognized by the user.

When the first judgment signal JS1 and the second judgment signal JS2 are input, the controller 126 may supply the first level selection signal SS to the selector 206. When the first level selection signal SS is input, the selector 206 may supply the first raw reference voltage Vreg1 and the first reference voltage Vref1 to the gamma driver 208.

The gamma driver 208 may generate the gamma voltages GMV by dividing the first raw reference voltage Vreg1 and the first reference voltage Vref1 supplied from the selector 206, and supply the generated gamma voltages GMV to the data driver 130. Then, even if a specific pattern image is displayed on the display unit 110, instances of the line crosstalk phenomenon occurring may be prevented or reduced.

When at least one of the first judgment signal JS1 or the second judgment signal JS2 is not input, the controller 126 may supply the second level selection signal SS to the selector 206. When the second level selection signal SS is input, the selector 206 may supply the second raw reference voltage Vreg2 and the second reference voltage Vref2 to the gamma driver 208.

The gamma driver 208 may generate the gamma voltages GMV by dividing the second raw reference voltage Vreg2 and the second reference voltage Vref2 supplied from the selector 206, and supply the generated gamma voltages GMV to the data driver 130. In this case, the power consumption of the display device 100 can be relatively reduced.

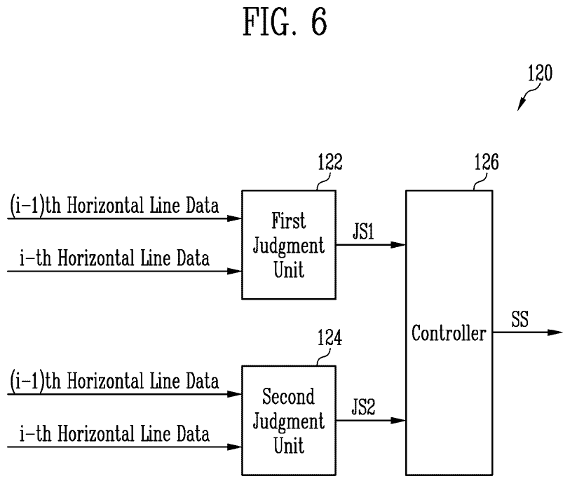

FIG. 7 is a waveform diagram illustrating the operation process of the timing controller shown in FIG. 6. In FIG. 7, Vsync may mean a vertical synchronization signal, and one cycle may represent one frame (1 Frame). In FIG. 7, when the judgment signals JS1 and JS2 are supplied, they are indicated by a logic high level voltage, and when the judgment signals JS1 and JS2 are not supplied, they are indicated by a logic low level voltage. However, embodiments according to the present disclosure are not limited thereto, and when the judgment signals JS1 and JS2 are supplied, they may be indicated by a logic low level voltage.

Referring to FIGS. 6 and 7, when the first judgment signal JS1 is not supplied from the first judgment unit 122 or the second judgment signal JS2 is not supplied from the second judgment unit 124, the controller 126 may supply the second level selection signal SS to the selector 206. The selector 206 receiving the second level selection signal SS may supply the second raw reference voltage Vreg2 and the second reference voltage Vref2 generated from the second voltage generator 204 to the gamma driver 208.

When the first judgment signal JS1 is supplied from the first judgment unit 122 and the second judgment signal JS2 is supplied from the second judgment unit 124, the controller 126 may supply the first level selection signal SS to the selector 206. The selector 206 receiving the first level selection signal SS may supply the first raw reference voltage Vreg1 and the first reference voltage Vref1 generated from the first voltage generator 202 to the gamma driver 208. Here, at least one of the first judgment signal JS1 or the second judgment signal JS2 may be implemented in a data format (e.g., set or predetermined data format).

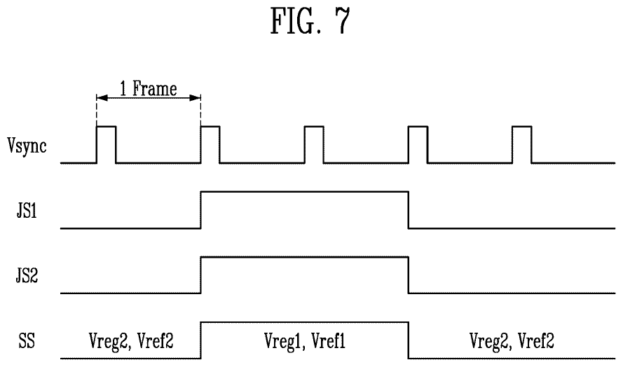

FIG. 8 is a diagram illustrating a display device according to some embodiments of the present disclosure. In describing FIG. 8, some redundant descriptions of components identical or similar to those in FIG. 1 may be omitted.

Referring to FIG. 8, a display device 100 according to some embodiments of the present disclosure may include a display unit 110, a timing controller 120a, a data driver 130, a scan driver 140, a gamma voltage generator 200, and a proximity sensor 300.

The proximity sensor 300 may detect whether an object (person or the like) is approaching. As an example, if it is determined that an object is approaching within a distance (e.g., a set or predetermined distance), the proximity sensor 300 may supply a proximity signal PS (for example, a logic high level voltage) to the timing controller 120a.

As an example, if it is determined that an object is positioned within a distance (e.g., a set or predetermined distance), the proximity sensor 300 may supply the proximity signal PS to the timing controller 120a, and in other cases, the proximity signal PS may not be supplied (or a logic low level voltage may be supplied). Here, the distance (e.g., the set or predetermined distance) may be set in advance during a manufacturing process, and as an example, may be a distance at which a user can visually recognize line crosstalk.

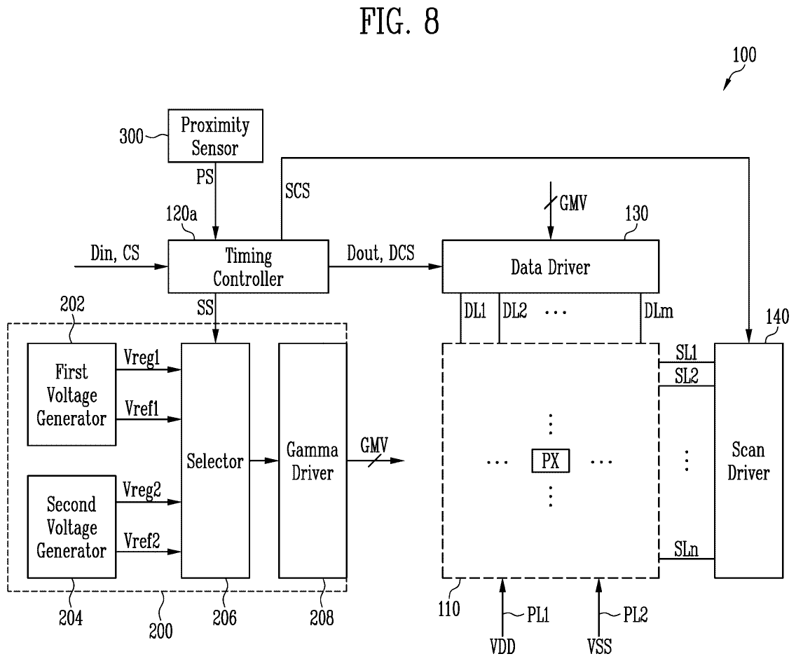

FIG. 9 is a diagram illustrating further details of a timing controller shown in FIG. 8. In describing FIG. 9, the same reference numerals are assigned to the same components as in FIG. 6, and some redundant descriptions may be omitted.

Referring to FIG. 9, the timing controller 120a according to some embodiments of the present disclosure may include a first judgment unit 122, a second judgment unit 124, and a controller 126a.

When the first judgment signal JS1, the second judgment signal JS2, and the proximity signal PS are input, the controller 126a may supply a first level selection signal SS to a selector 206. When the first level selection signal SS is input, the selector 206 may supply the first raw reference voltage Vreg1 and the first reference voltage Vref1 to a gamma driver 208.

The gamma driver 208 may generate the gamma voltages GMV by dividing the first raw reference voltage Vreg1 and the first reference voltage Vref1 supplied from the selector 206, and supply the generated gamma voltages GMV to the data driver 130. Then, even if a specific pattern image is displayed on the display unit 110, instances of the line crosstalk phenomenon occurring may be prevented or reduced.

When at least one of the first judgment signal JS1, the second judgment signal JS2, or the proximity signal PS is not input, the controller 126a may supply a second level selection signal SS to the selector 206. When the second level selection signal SS is input, the selector 206 may supply the second raw reference voltage Vreg2 and the second reference voltage Vref2 to the gamma driver 208.

The gamma driver 208 may generate the gamma voltages GMV by dividing the second raw reference voltage Vreg2 and the second reference voltage Vref2 supplied from the selector 206, and supply the generated gamma voltages GMV to the data driver 130. In this case, the power consumption of the display device 100 can be relatively reduced.

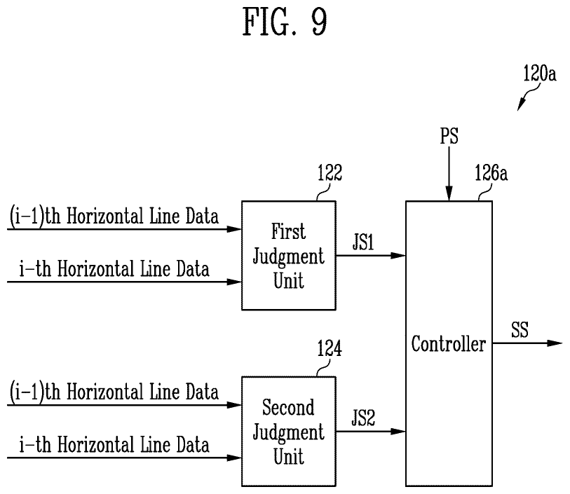

FIG. 10 is a waveform diagram illustrating the operation process of the timing controller shown in FIG. 9. In FIG. 10, when the judgment signals JS1 and JS2 and the proximity signal PS are supplied, they are indicated by a logic high level voltage, and when the judgment signals JS1 and JS2 and the proximity signal PS are not supplied, they are indicated by a logic low level voltage. However, embodiments according to the present disclosure are not limited thereto, and when the judgment signals JS1 and JS2 and the proximity signal PS are supplied, they may be indicated by a logic low level voltage.

Referring to FIGS. 9 and 10, when at least one of the first judgment signal JS1, the second judgment signal JS2, or the proximity signal PS (at least one of JS1, JS2, or PS) is not supplied, the controller 126a may supply the second level selection signal SS to the selector 206. The selector 206 receiving the second level selection signal SS may supply the second raw reference voltage Vreg2 and the second reference voltage Vref2 generated from the second voltage generator 204 to the gamma driver 208.

When the first judgment signal JS1, the second judgment signal JS2, and the proximity signal PS are supplied, the controller 126a may supply the first level selection signal SS to the selector 206. The selector 206 receiving the first level selection signal SS may supply the first raw reference voltage Vreg1 and the first reference voltage Vref1 generated from the first voltage generator 202 to the gamma driver 208. Meanwhile, at least one of the first judgment signal JS1, the second judgment signal JS2, or the proximity signal PS may be implemented in a data format (e.g., a set or predetermined data format).

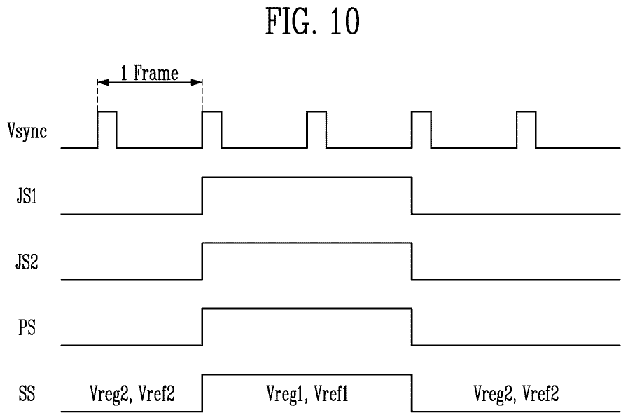

FIG. 11 is a diagram illustrating further details of the timing controller shown in FIG. 8. In describing FIG. 11, some redundant descriptions of components identical or similar to those in FIG. 6 may be omitted.

Referring to FIG. 11, the timing controller 120a according to some embodiments of the present disclosure may include a first judgment unit 122, a second judgment unit 124, a controller 126b, and a dimming level judgment unit 128.

The dimming level judgment unit 128 may generate a third judgment signal JS3 based on a current dimming level included in the control signal CS. As an example, the display device 100 may compare the current dimming level with a third threshold value, and when the current dimming level is set to be greater than or equal to the third threshold value, supply the third judgment signal JS3 (or a logic high level voltage) to the controller 126b.

The dimming level may refer to a maximum display luminance that the display device 100 can emit light. For example, as the dimming level increases, the maximum display luminance displayed on the display unit 110 may increase. The maximum display luminance may be luminance measured when the entire display unit 110 emits light at a maximum grayscale set in the display device 100.

Assuming that the maximum dimming level at which the display device 100 can be driven is 100 (or 100%), the third threshold value may be selected as one of values less than or equal to 50 (or 50%) (for example, a value greater than or equal to 20). When the display device 100 is driven at a high dimming level, the luminance range of the display unit 110 may increase, which may increase the probability that line crosstalk will be visually recognized by a user. When the display device 100 is driven at a low dimming level, the luminance range of the display unit 110 may be relatively reduced, reducing the probability that line crosstalk will be visually recognized by a user.

When the current dimming level is determined to be greater than or equal to the third threshold value, line crosstalk may be visually recognized by a user. In response, the dimming level judgment unit 128 may supply the third judgment signal JS3 to the controller 126b.

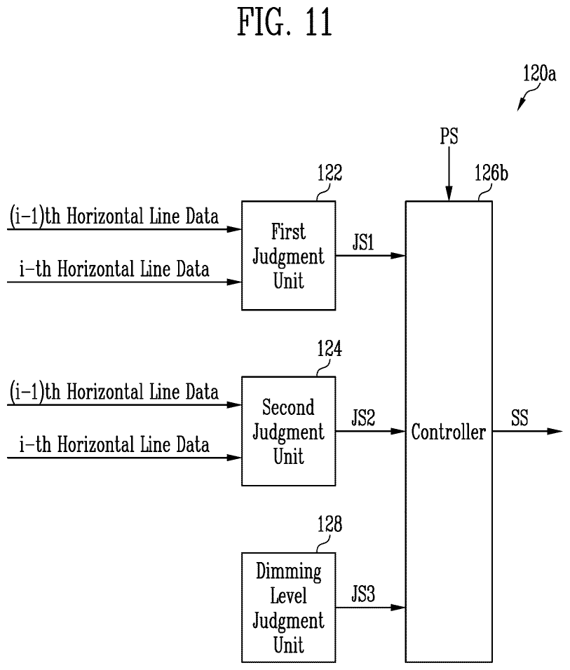

FIG. 12 is a waveform diagram illustrating the operation process of the timing controller shown in FIG. 11. In FIG. 12, when the judgment signals JS1, JS2, and JS3 and the proximity signal PS are supplied, they are indicated by a logic high level voltage, and when the judgment signals JS1, JS2, and JS3 and the proximity signal PS are not supplied, they are indicated by a logic low level voltage. However, embodiments according to the present disclosure are not limited thereto, and when the judgment signals JS1, JS2, and JS3 and the proximity signal PS are supplied, they may be indicated by a logic low level voltage.

Referring to FIGS. 11 and 12, when at least one of the first judgment signal JS1, the second judgment signal JS2, the third judgment signal JS3, or the proximity signal PS (at least one of JS1, JS2, JS3, or PS) is not supplied, the controller 126b may supply the second level selection signal SS to the selector 206. The selector 206 receiving the second level selection signal SS may supply the second raw reference voltage Vreg2 and the second reference voltage Vref2 generated from the second voltage generator 204 to the gamma driver 208.

When the first judgment signal JS1, the second judgment signal JS2, the third judgment signal JS3, and the proximity signal PS are supplied, the controller 126b may supply the first level selection signal SS to the selector 206. The selector 206 receiving the first level selection signal SS may supply the first raw reference voltage Vreg1 and the first reference voltage Vref1 generated from the first voltage generator 202 to the gamma driver 208.

Meanwhile, in the above description, the judgment signals JS1, JS2, and JS3 and the proximity signal PS are described as having voltages of a logic high level or a logic low level, but embodiments of the present disclosure are not limited thereto. As an example, at least one of the judgment signals JS1, JS2, or JS3 and the proximity signal PS may be data (e.g., set or predetermined data).

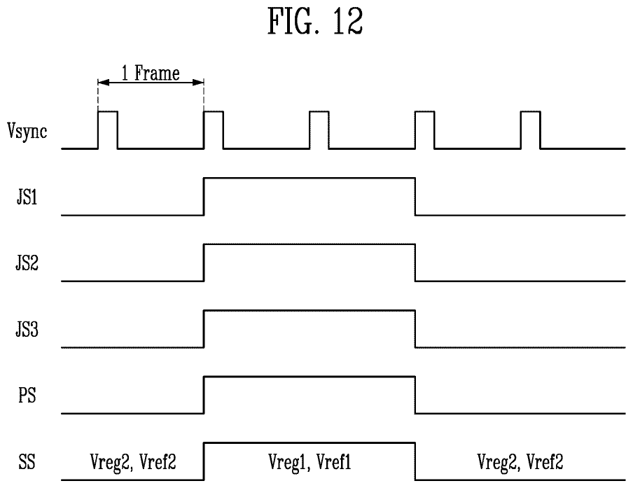

FIG. 13 is a flow diagram illustrating a method of driving a display device according to some embodiments of the present disclosure. Although FIG. 13 illustrates various operations in a method of driving a display device according to some embodiments, embodiments according to the present disclosure are not limited thereto, and according to various embodiments, the method may include additional operations, or fewer operations, or the order of operations may vary, unless otherwise stated or implied, without departing from the spirit and scope of embodiments according to the present disclosure.

Referring to FIGS. 1, 6, and 13, after a power source is input to the display device 100, the second voltage generator 204 may be driven to supply the second raw reference voltage Vreg2 and the second reference voltage Vref2 to the gamma driver 208 (S1302). The gamma driver 208 may generate the gamma voltages GMV based on the second raw reference voltage Vreg2 and the second reference voltage Vref2, and supply the generated gamma voltages GMV to the data driver 130.

The data driver 130 may generate the data signal using the gamma voltages GMV and supply the data signal to the pixels PX through the data lines DL1 to DLm.

That is, in a normal driving state of the display device 100, the second voltage generator 204 may be driven, and thus the power consumption of the display device 100 can be relatively reduced.

The first judgment unit 122 may detect the amount of change in data in units of horizontal lines. As an example, the first judgment unit 122 may generate, as the first judgment value, an absolute value of a value obtained by subtracting the data of each of the second pixels located in the current horizontal line from the data of each of the first pixels located in the previous horizontal line (S1304), and compare the first judgment value with a threshold value (S1306).

When the first judgment value is greater than or equal to the threshold value, the first judgment unit 122 may generate the first judgment signal JS1 and supply the first judgment signal JS1 to the controller 126 (S1308). When the first judgment value is less than the threshold value, the first judgment unit 122 may maintain the driving of the second voltage generator 204 (S1306).

The second judgment unit 124 may detect whether data has changed in units of horizontal lines. As an example, the second judgment unit 124 may compare the data of each of the first pixels located in the previous horizontal line with the data of each of the second pixels located in the current horizontal line to determine whether data has changed. The second judgment unit 124 may generate the second judgment value indicating the number of pixels whose data has changed in response to the comparison result (S1310).

The second judgment unit 124 may determine whether the second judgment value is set to be greater than or equal to the first threshold value and less than or equal to the second threshold value (S1312). When the second judgment value is determined to be greater than or equal to the first threshold value and less than or equal to the second threshold value, the second judgment unit 124 may generate the second judgment signal JS2 and supply the second judgment signal JS2 to the controller 126 (S1314). When the second judgment value is not determined to be greater than or equal to the first threshold value and less than or equal to the second threshold value, the driving of the second voltage generator 204 may be maintained (S1312). The operations S1304 to S1308 and S1310 to S1314 may be performed in parallel, but embodiments according to the present disclosure are not limited thereto. As an example, the operations S1304 to S1308 and S1310 to S1314 may be performed sequentially.

The controller 126 may determine whether the first judgment signal JS1 and the second judgment signal JS2 are input (S1316). When at least one of the first judgment signal JS1 or the second judgment signal JS2 is not input, the controller 126 may supply the second level selection signal SS to the selector 206. The selector 206 receiving the second level selection signal SS may electrically connect the second voltage generator 204 and the gamma driver 208, and thus the driving of the second voltage generator 204 may be maintained.

When the first judgment signal JS1 and the second judgment signal JS2 are input, the controller 126 may supply the first level selection signal SS to the selector 206. The selector 206 receiving the first level selection signal SS may electrically connect the first voltage generator 202 and the gamma driver 208, and thus the first voltage generator 202 may be driven (S1318). When the first voltage generator 202 is driven, the first raw reference voltage Vreg1 and the first reference voltage Vref1 may be supplied to the gamma driver 208, and the gamma driver 208 may generate the gamma voltages GMV based on the first raw reference voltage Vreg1 and the first reference voltage Vref1.

That is, when a pattern that may cause line crosstalk is displayed on the display unit 110, the first voltage generator 202 may be driven, thereby relatively reducing the power consumption of the display device 100.

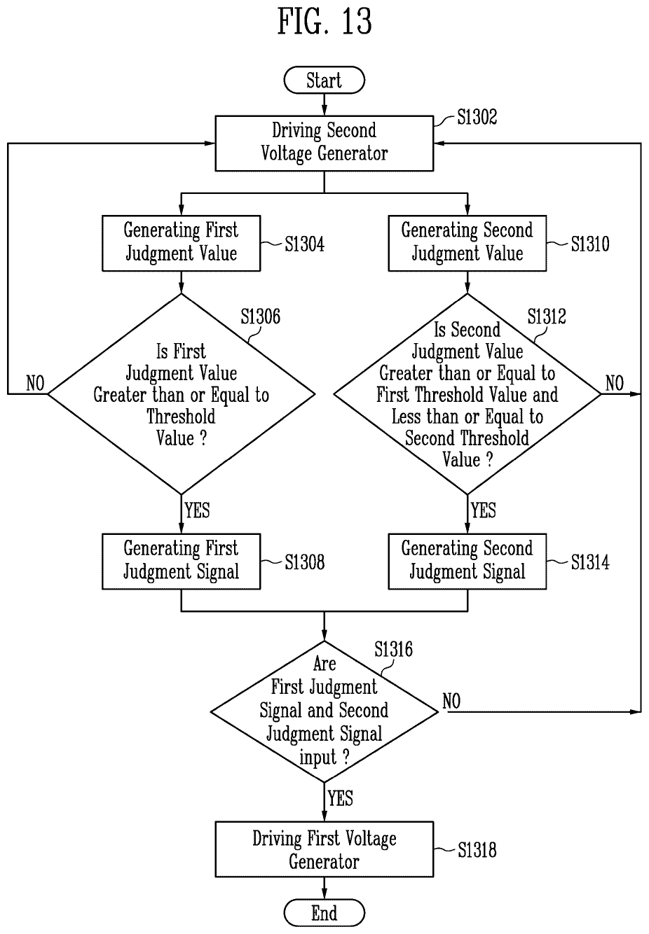

FIG. 14 is a flow diagram illustrating a method of driving a display device according to some embodiments of the present disclosure. Although FIG. 14 illustrates various operations in a method of driving a display device according to some embodiments, embodiments according to the present disclosure are not limited thereto, and according to various embodiments, the method may include additional operations, or fewer operations, or the order of operations may vary, unless otherwise stated or implied, without departing from the spirit and scope of embodiments according to the present disclosure.

In describing FIG. 14, some redundant descriptions of components identical or similar to those in FIG. 13 may be omitted.

Referring to FIGS. 8, 11, and 14, after a power source is input to the display device 100, the second voltage generator 204 may be driven (S1302).

The proximity sensor 300 may determine whether an object is positioned within a distance (e.g., a set or predetermined distance) (S1320 and S1322). If it is determined that the object is positioned within the distance (e.g., the set or predetermined distance), the proximity sensor 300 may generate the proximity signal PS and supply the proximity signal PS to the controller 126b (S1324). If the object is determined to be positioned outside the distance (e.g., the set or predetermined distance), the proximity sensor 300 may not generate the proximity signal PS. In this case, the driving of the second voltage generator 204 may be maintained.

The dimming level judgment unit 128 may determine whether a current dimming level is greater than or equal to the third threshold value (S1326 and S1328). When the current dimming level is set to be greater than or equal to the third threshold value, the dimming level judgment unit 128 may generate the third judgment signal JS3 (or a logic high level voltage) and supply the third judgment signal JS3 to the controller 126b (S1330). When the current dimming level is determined to be less than the third threshold value, the dimming level judgment unit 128 may not generate the third determination signal JS3. In this case, the driving of the second voltage generator 204 may be maintained.

The operations S1304 to S1308, S1310 to S1314, S1320 to S1324, and S1326 to S1330 may be performed in parallel, but embodiments according to the present disclosure are not limited thereto. As an example, at least some of the operations S1304 to S1308, S1310 to S1314, S1320 to S1324, and S1326 to S1330 may be performed sequentially. In addition, the operations S1320 to S1324 or S1326 to S1330 may be omitted.

The controller 126b may determine whether the first judgment signal JS1, the second judgment signal JS2, the third judgment signal JS3, and the proximity signal PS are input (S1332). When at least one of the first judgment signal JS1, the second judgment signal JS2, the third judgment signal JS3, or the proximity signal PS is not input, the controller 126b may supply the second level selection signal SS to the selector 206. The selector 206 receiving the second level selection signal SS may electrically connect the second voltage generator 204 and the gamma driver 208, and thus the driving of the second voltage generator 204 may be maintained.

When the first judgment signal JS1, the second judgment signal JS2, the third judgment signal JS3, and the proximity signal PS are input, the controller 126b may supply the first level selection signal SS to the selector 206. The selector 206 receiving the first level selection signal SS may electrically connect the first voltage generator 202 and the gamma driver 208, and thus the first voltage generator 202 may be driven (S1334). When the first voltage generator 202 is driven, the first raw reference voltage Vreg1 and the first reference voltage Vref1 may be supplied to the gamma driver 208, and the gamma driver 208 may generate the gamma voltages GMV based on the first raw reference voltage Vreg1 and the first reference voltage Vref1.

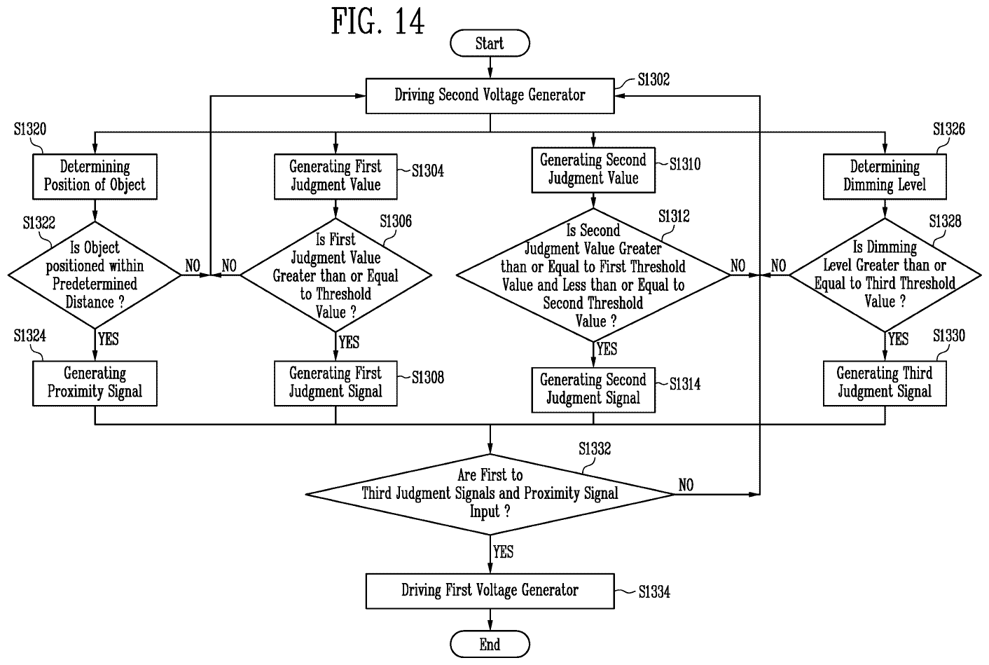

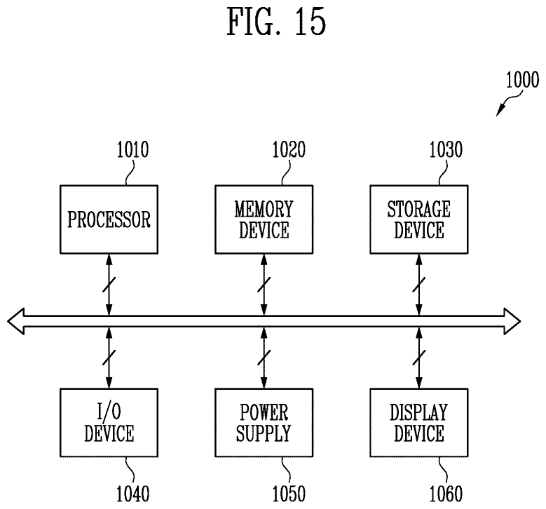

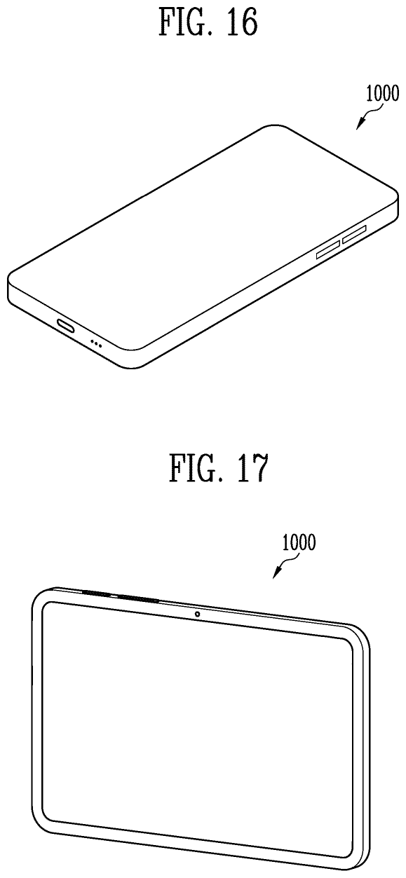

FIG. 15 is a schematic block diagram illustrating an electronic device 1000 including a display device according to some embodiments. FIG. 16 is a schematic diagram illustrating an example where the electronic device 1000 of FIG. 15 is a smartphone. FIG. 17 is a schematic diagram illustrating an example where the electronic device 1000 of FIG. 15 is a tablet computer.

Referring to FIGS. 15 to 17, the electronic device 1000 may include a processor 1010, a memory device 1020, a storage device 1030, an input/output (I/O) device 1040, a power supply 1050, and a display device 1060. The display device 1060 may be the display device 100 of FIG. 1 and FIG. 8. The electronic device 1000 may further include various ports for communication with a video card, a sound card, a memory card, a USB device, or other systems. According to some embodiments, as illustrated in FIG. 16, the electronic device 1000 may be a smartphone. According to some embodiments, as illustrated in FIG. 17, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. According to some embodiments, the processor 1010 may include at least one of a central processing unit, an application processor, a graphic processing unit, a communication processor, an image signal processor, a controller, or the like. The processor 1010 may be connected to other components through an address bus, a control bus, a data bus, and the like. According to some embodiments, the processor 1010 may be connected to an expansion bus such as a peripheral component interconnect (PCI) bus. According to some embodiments, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. According to some embodiments, the display device 1060 may be integrated with the I/O device 1040.

The power supply 1050 may supply power needed to perform the operation of the electronic device 1000. For example, the power supply 1050 may include a power management integrated circuit (PMIC). According to some embodiments, the power supply 1050 may supply power to the display device 1060.

The display device 1060 may display images in response to image data signals and/or control signals from the processor 1010. The display device 1060 may be connected to other components through the buses or other communication links.

In a display device and the method of driving the same according to some embodiments of the present disclosure, when a crosstalk pattern is detected, gamma voltages may be generated based on a first raw reference voltage and a first reference voltage in which the rising and falling of a first driving power source are compensated, thereby relatively improving the display quality.

In addition, in a display device and the method of driving the same according to some embodiments of the present disclosure, when a crosstalk pattern is not detected, gamma voltages may be generated based on a second raw reference voltage and a second reference voltage in which the rising of the first driving power source is compensated, thereby relatively reducing the power consumption.

However, the characteristics of embodiments according to the present disclosure are not limited to the above-described characteristics, and may be variously extended without departing from the spirit and scope of embodiments according to the present disclosure.

As described above, aspects of some embodiments of the present disclosure have been described with reference to the drawings. However, those skilled in the art will appreciate that various modifications and changes can be made to the disclosed embodiments without departing from the spirit and scope of embodiments according to the present disclosure as set forth in the appended claims, and their equivalents.

What is claimed is:

1. A display device comprising:
pixels configured to generate a predetermined light in response to a driving current supplied from a first driving power source;
a data driver configured to generate data signals using gamma voltages and to supply the data signals to the pixels;
a first voltage generator configured to generate a first raw reference voltage and a first reference voltage in which rising and falling of the first driving power source are compensated;
a second voltage generator configured to generate a second raw reference voltage and a second reference voltage in which rising of the first driving power source is compensated;
a selector configured to supply the first raw reference voltage and the first reference voltage, or the second raw reference voltage and the second reference voltage to a gamma driver in response to a selection signal; and
a timing controller configured to compare data in units of horizontal lines and to generate the selection signal based on a comparison result.

2. The display device of claim 1, wherein the gamma driver is configured to generate the gamma voltages by dividing the first raw reference voltage and the first reference voltage, or the second raw reference voltage and the second reference voltage.

3. The display device of claim 1, wherein the selector is configured to supply the first raw reference voltage and the first reference voltage to the gamma driver based on a first level selection signal being input, and to supply the second raw reference voltage and the second reference voltage to the gamma driver based on a second level selection signal being input.

4. The display device of claim 3, wherein the timing controller includes:
a first judgment unit configured to generate a first judgment value corresponding to a difference between data of first pixels of a previous horizontal line and data of second pixels of a current horizontal line, and to generate a first judgment signal based on the first judgment value being greater than or equal to a threshold value; and
a second judgment unit configured to compare the data of the first pixels and the data of the second pixels to generate a second judgment value corresponding to whether data has changed, and configured to generate a second judgment signal based on the second judgment value being greater than or equal to a first threshold value and less than or equal to a second threshold value.

5. The display device of claim 4, wherein each of the first judgment unit and the second judgment unit is configured to compare data of a first pixel and a second pixel located on the same vertical line.

6. The display device of claim 4, wherein based on a maximum value of the first judgment value being 100, the threshold value is set to a value greater than or equal to 40.

7. The display device of claim 4, wherein based on a maximum value of the second judgment value being 100, the first threshold value is set to a value greater than or equal to 5, and the second threshold value is set to a value higher than the first threshold value and less than or equal to 70.

8. The display device of claim 4, wherein the timing controller further includes:
a controller configured to supply the first level selection signal to the selector based on the first judgment signal and the second judgment signal being input, and to supply the second level selection signal to the selector in other cases.

9. The display device of claim 4, further comprising:
a proximity sensor configured to detect an object is approaching and to generate a proximity signal based on the object being positioned within a predetermined distance.

10. The display device of claim 9, wherein the timing controller further includes:
a controller configured to supply the first level selection signal to the selector based on the first judgment signal, the second judgment signal, and the proximity signal being input, and to supply the second level selection signal to the selector in other cases.

11. The display device of claim 4, further comprising:
a dimming level judgment unit configured to generate a third judgment signal based on a current dimming level of the display device being greater than or equal to a predetermined third threshold value.

12. The display device of claim 11, wherein the third threshold value has a value less than or equal to 50% of a maximum dimming level at which the display device can be driven.

13. The display device of claim 11, wherein the timing controller further includes:
a controller configured to supply the first level selection signal to the selector based on the first judgment signal, the second judgment signal, and the third judgment signal being input, and to supply the second level selection signal to the selector in other cases.

14. A method of driving a display device comprising:
generating a first raw reference voltage and a first reference voltage in which rising and falling of a first driving power source are compensated;
generating a second raw reference voltage and a second reference voltage in which rising of the first driving power source is compensated;
comparing data in units of horizontal lines;
generating gamma voltages using the first raw reference voltage and the first reference voltage, or the second raw reference voltage and the second reference voltage based on a comparison result of the data; and
generating a data signal using the gamma voltages.

15. The method of claim 14, wherein the comparing the data in units of horizontal lines includes:
generating a first judgment value corresponding to a difference between data of first pixels of a previous horizontal line and data of second pixels of a current horizontal line;
generating a first judgment signal based on the first judgment value being greater than or equal to a predetermined threshold value;
generating a second judgment value corresponding to whether the data of the first pixels and the data of the second pixels have changed; and
generating a second judgment signal based on the second judgment value being greater than or equal to a first threshold value and less than or equal to a second threshold value.

16. The method of claim 15, wherein the generating the gamma voltages includes:
generating the gamma voltages using the first raw reference voltage and the first reference voltage based on the first judgment signal and the second judgment signal being input, and generating the gamma voltages using the second raw reference voltage and the second reference voltage in other cases.

17. The method of claim 15, further comprising:
detecting an object is approaching and generating a proximity signal based on the object being positioned within a predetermined distance.

18. The method of claim 17, wherein the generating the gamma voltages includes:
generating the gamma voltages using the first raw reference voltage and the first reference voltage based on the first judgment signal, the second judgment signal, and the proximity signal being input, and generating the gamma voltages using the second raw reference voltage and the second reference voltage in other cases.

19. The method of claim 15, further comprising:
generating a third judgment signal based on a current dimming level of the display device being greater than or equal to a predetermined third threshold value.

20. An electronic device, comprising:
a processor configured to provide input image data;
a display device configured to display an image based on the input image data; and
wherein the display device comprising:
pixels configured to generate a predetermined light in response to a driving current supplied from a first driving power source;
a data driver configured to generate data signals using gamma voltages and supplying the data signals to the pixels;
a first voltage generator configured to generate a first raw reference voltage and a first reference voltage in which rising and falling of the first driving power source are compensated;
a second voltage generator configured to generate a second raw reference voltage and a second reference voltage in which rising of the first driving power source is compensated;
a selector configured to supply the first raw reference voltage and the first reference voltage, or the second raw reference voltage and the second reference voltage to a gamma driver in response to a selection signal; and
a timing controller configured to compare data in units of horizontal lines and to generate the selection signal based on a comparison result.
